(19) United States
(12) Patent Application Publication
(10) Pub. No.: US 2005/0216768 A1
(43) Pub. Date: Sep. 29, 2005

(54) System and method for authenticating a user of an account

(75) Inventor: David Eppert, Vancouver (CA)

Correspondence Address: MCCARTHY TETRAULT LLP, SUITE 4900, P.O. BOX 48, 66 WELLINGTON ST. WEST, TORONTO, ON, M5K 1E6, CA

(73) Assignee: Queue Global Information Systems Corp.

(21) Appl. No.: 11/078,283

(22) Filed: Mar. 14, 2005

Related U.S. Application Data
(60) Provisional application No. 60/553,119, filed on Mar. 16, 2004.

(30) Foreign Application Priority Data
Nov. 17, 2004 (CA) 2,487,787

(51) Int. Cl. H04L 9/00

(52) U.S. Cl. 713/201

(57) ABSTRACT

The invention provides a system and method of authenticating a user of an account at a service system using an authentication system is provided. For the method, it comprises: after the user successfully completes an initial sign-on procedure with the service system, providing an authentication question to the user from the authentication system; receiving and analyzing an answer from the user to the question; if the answer provides a sufficient level of confidence in the authenticity of the user, then providing a sign-on password to the user and to the service system for use for the user to submit the password to the service system to access the account.

### FIELD OF THE INVENTION

The present invention relates to an authentication system and method for a user accessing an account.

### BACKGROUND

In a transaction system, it is often necessary to authenticate the parties involved in the transaction. With the advent of electronic transaction systems, the authentication of parties is more difficult as personal contact between the parties is not available. Authentication between the parties may be achieved in a number of ways, the most common of which is to utilize an account and a password. The password is confidential to the user and can be authenticated to provide access to the system. However, the provision of a password is vulnerable either through interception of the password and replay or by observation of a user inputting the password which can subsequently be utilized by an interloper.

There is also increased concern about the privacy of information that is supplied by participants in such transactions and more stringent rules and regulations requiring the maintenance of the confidentiality of such information and the consent of the parties to disclose such information. Theft of identity is an increasing concern and the consequences of loss of such identity may range from simple inconvenience of having to replace documentation to significant financial loss.

There is therefore, the need for an authentication system which provides an enhanced level of confidence in the authentication but does not disclose the identity of the individual.

### SUMMARY

In general terms therefore, the present invention provides an authentication system in which a record is established with a subset of information about an entity. The subset of information is insufficient to identify the user. The record characterizes the information into a number of categories and selects questions regarding the available information from those categories in a predetermined sequence. Questions are forwarded to the user and the answers monitored to determine whether or not the required confidence of authentication is obtained. A decision to authenticate or reject a user is made on the basis of the results obtained.

Preferably, the record includes questions for which only the user can know the answer and this category of questions is included within the questions presented and the information updated for subsequent use.

In particular, in one aspect of the embodiment, a method of authenticating a user of an account at a service system using an authentication system is provided. The method comprises: after the user successfully completes an initial sign-on procedure with the service system, providing an authentication question to the user from the authentication system; receiving and analyzing an answer from the user to the question; if the answer provides a sufficient level of confidence in the authenticity of the user, then providing a sign-on randomly generated password to the user and to the service system for use for the user to submit the random password to the service system which submit the random password to the authentication system for the user to access the account.

The method may further automatically submit the sign-on random password from the user to the service system for verification by the verification system; and upon completion of verification, allow the user access to the account.

The method may further have the authentication system storing account information related to the user obtained from the service system and the answer received from the user; and also, the answer for the question may be distinct from the account information.

In the method, if the answer does not provide the sufficient level of confidence, then the system may not authenticate the user. In the method, for one of the questions, its expected answer may be a given answer provided by the user.

In the method, the given answer may be stored with the expected answers and it may become an expected answer for the question.

In the method, the sign-on password may be generated utilizing an answer from a question.

For the method, it may be completed in one session which extends from the initial sign-on procedure.

For the method, the expected answers may each be a single alphanumeric character.

In a second aspect, a system for authenticating a user of an account is provided. The system comprises: an authentication system; a service system having a plurality of accounts and users for the plurality of accounts; and a set of security identification tags for the users. In the system, after the user successfully completes an initial sign-on procedure with the service system, the authentication system may provide an authentication question or set of questions to the user. Also, after the user provides an answer to the authentication question; the authentication system receives and analyzes an answer from the user to the question. Thereafter, if the answer provides a sufficient level of confidence in the authenticity of the user, the authentication system provides a sign-on randomly generated password to the user and to the service system for use for the user service system to submit the password to the service system authentication system. The authentication system receives and analyzes the random password from the service system. Thereafter, if the random password matches that stored by the authentication system, the user is permitted to access the account.

In the system, the authentication system may automatically submit the sign-on password from the user to the service system for verification by the authentication system. Also, upon completion of verification, the authentication system may automatically allow the user to access the account.

In other aspects various combinations of sets and subsets of the above aspects are provided.

### BRIEF DESCRIPTION OF DRAWINGS

An embodiment of the invention will now be described by way of example only with reference to the accompanying drawings in which:

FIG. 1 is a schematic representation of an electronic transaction system relating to an embodiment of the invention;

FIG. 2 is a block diagram of an authentication system of the transaction system of FIG. 1;

FIG. 3 is a flowchart showing operation of the transaction system of FIG. 1;

FIG. 4 is a GUI showing a sign-on screen generated by the system of FIG. 1;

FIG. 5 is a representation of a record relating to a user of the system of FIG. 1; and

FIG. 6 is a flowchart showing the generation of authentication information using the record of FIG. 3.

### DESCRIPTION OF EMBODIMENTS

The description which follows, and the embodiments described therein, are provided by way of illustration of an example, or examples, of particular embodiments of the principles of the present invention. These examples are provided for the purposes of explanation, and not limitation, of those principles and of the invention. In the description, which follows, like parts are marked throughout the specification and the drawings with the same respective reference numerals.

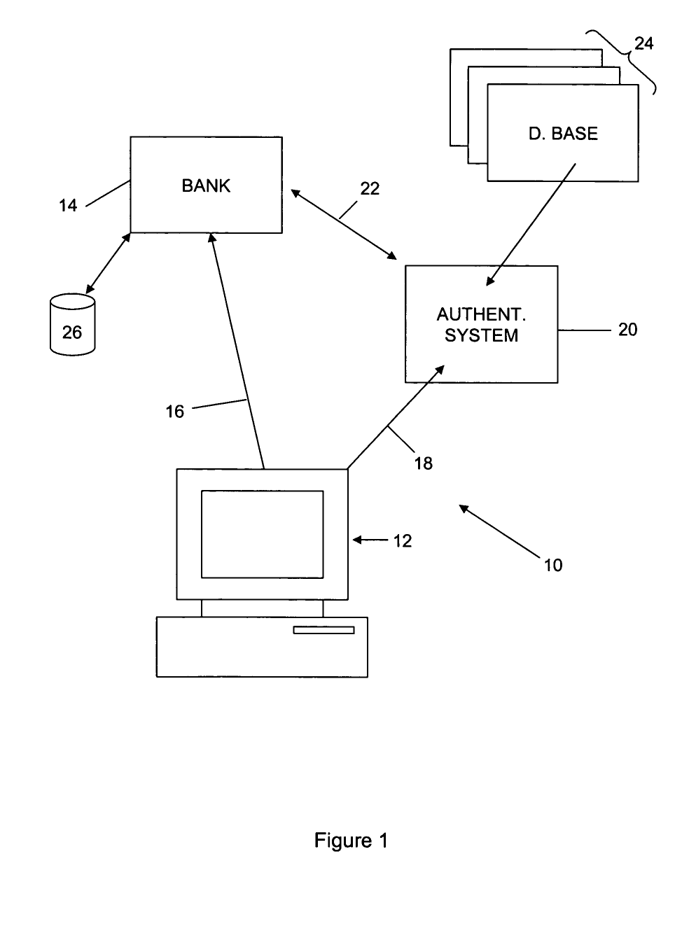

Referring therefore to FIG. 1, an electronic transaction system generally indicated at 10 includes client 12 and service system 14, which for the purposes of illustration is a financial institution. The service provider may be any on-line service provider offering services to account holders. Client 12 is connected through a communication network 16 to financial institution 14 and can request transactions and exchange information over the communication network. In the embodiment the communication network is provided by an Internet connection and network, but other networks may be provided, such as modem communication links, as are known in the art. Client 12 is also connected through a communication system 18, which follows networking protocols of the Internet, to authentication system 20. Authentication system 20 is also connected to the financial institution through a link 22, which may also follow Internet network protocols. As such, client 12, financial institution 14 and authentication system 20 are able to communicate with each other, separately and collectively.

Authentication system 20 provides part of the authentication process for the user. It includes a database 24 representing records of users of financial institution 14 and its users. Authentication system 20 may be implemented in at least two forms. A first form is a model where it implemented as a local sub-system within client 12. A second form is an enterprise model wherein it is a separate system from client 12. In the second form, additional financial institutions may be in communication with authentication system 20 through other links. For the remainder of the description, authentication system 20 is described as being an enterprise model.

For each user having an account at financial institution 14, it has a record in database 26 containing biographical particulars of the user, a list of his associated financial accounts, and an account access code, a password associated with the access code, as well as other data. As part of the authentication process, the user at client 12 must provide financial institution 14 with the appropriate account access code and password. Upon full completion of the authentication process, the user is granted access to his associated financial accounts, allowing him to view their balances, initiate transfer of funds, pay bills and perform other processes which would ordinarily be made by the user in person at a branch of financial institution 14.

Further detail is now provided on elements within client 12, financial institution 14 and authentication system 20. It will be appreciated that each of client 12, financial institution 14 and authentication system 20 operates a computing device which each has a microprocessor (not shown), memory (not shown) such as RAM, secondary storage, such as a disk drive and data input/output modules (not shown) providing access to communication links which enable each element to operate software, firmware and hardware-based applications associated with the embodiment.

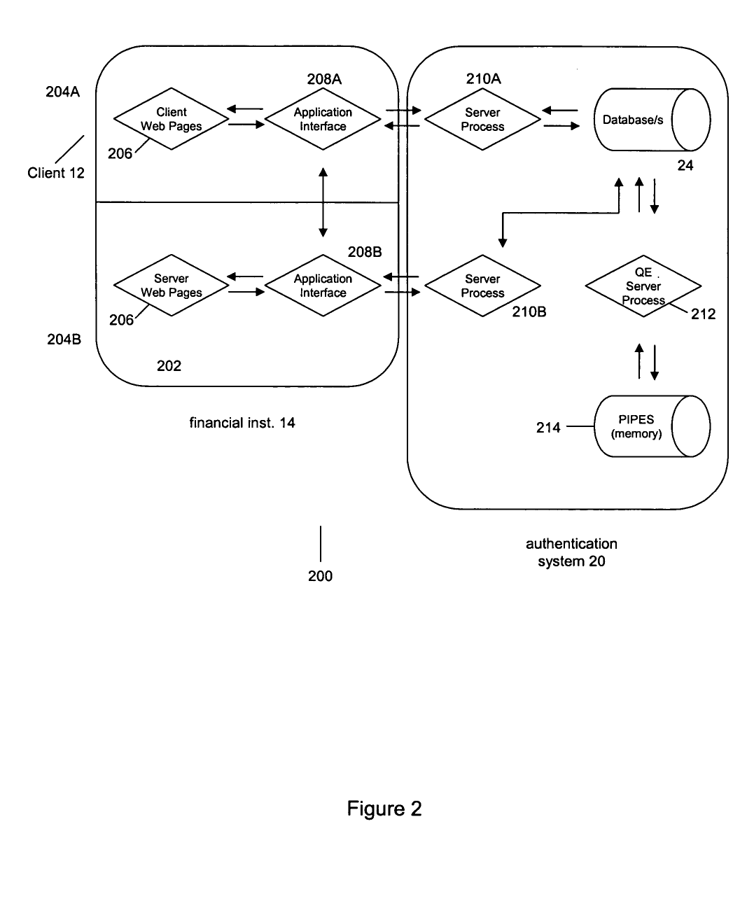

Referring FIG. 2, as shown generally at 200, components of applications in client 12 and authentication system 20 are shown. Client application 202 operates on client 12 and is composed of several modules embodied in software. Client application 202 collectively provides separate interfaces to applications operating on authentication system 20 and financial institution 14. In other embodiments, separate applications can be provided in client 12 for each interface. Details regarding application 202 focus on the initial log-in and verification steps occurring amongst client 12, financial institution 14 and authentication system 20.

Interface 204A in client application 202 generally handles interactions between the client 12 and financial institution 14. Interface 204B is typically located at financial institution 14 and generally handles interactions between the financial institution 14 and authentication system 20. Each interface provides a series of sessions, streams for the system amongst the entities. Using GUIs, related screens and windows are provided to the user, with each screen and window providing either a request for data from the user or a notification of an event to the user. In the embodiment, the screens and windows are provided as a series of web pages to the user. Each interface 204 comprises of a series of screens and windows 206A and 206B and Application Program Interfaces (API) 208A and 208B which controls presentation of the screens and windows to the user. The underlying programming language used to create and manage modules controlling generation of screens, windows, API and data are implemented in C++ and HTML; however, other implementations, using languages such as Java, JSP, ASP, PHP, may also be provided. All interfaces operate to provide a set of threads which collectively provide a seamless flow of windows and screens to the user, appearing that a single sign-on process is being executed.

Similarly, at authentication system 20, server processes 210A and 210B process requests and data and communicate with corresponding interfaces 208A and 208B. This API-process interface follows interfacing techniques known in the art. Within authentication system 20, process 210A communicates with database 24 and pipes/shared memory 214. Query processing engine 212 is also provided which controls operation of a second step of authentication, described in further detail below. Query processing engine 212 also has access to token database 214 for storage of temporary data relating to a sign-on session. It is noted that for the local sub-system, one or more of process 210B, query processing engine 212, pipes memory 214 and database 24 may be more closely associated with financial institution 14.

Further detail on elements in financial institution 14 are provided. Authentication system 20 also provides a separate API to financial institution 14. Client application 202 communicates through its API to financial institution 14 when communications are required between financial service 14 and authentication system 20 to its API-process interface. Financial institution 14 has a database 26 (FIG. 1) to store data relating to queries and temporary storage to store data before it is provided to database 214.

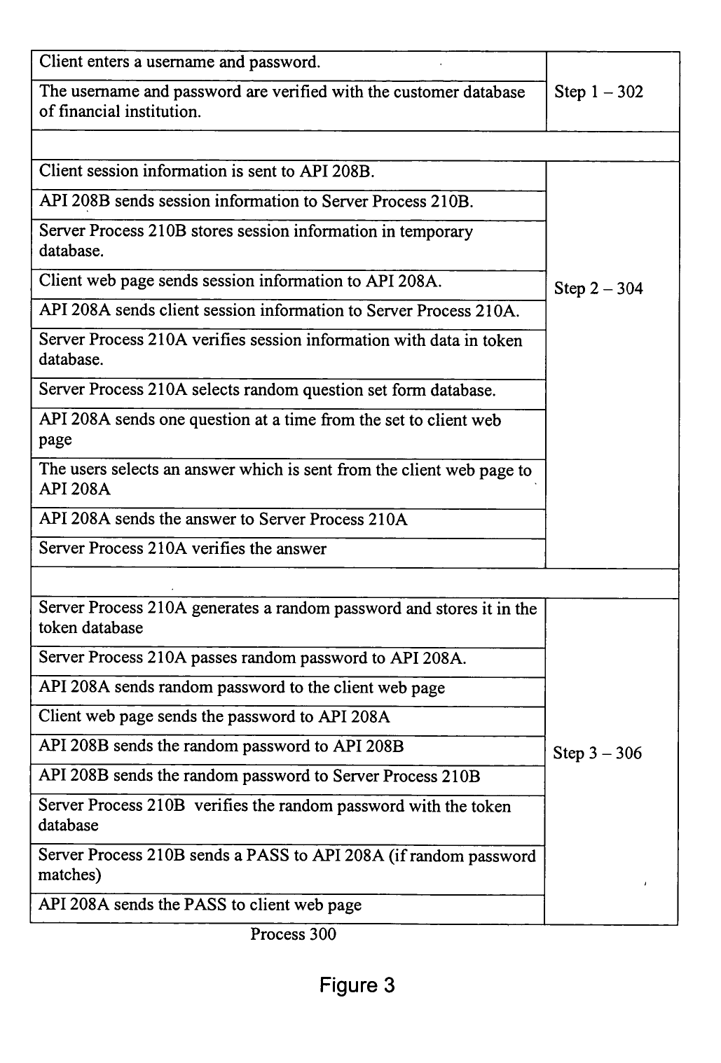

Referring to FIG. 3, when a user having a financial account at financial institution 14 wishes to access the financial account at client 12, the embodiment provides a three step process to authenticate the user. The process is shown generally at 300. The first step, shown at 302, involves an initial log-on of a user at client 12 to financial institution 14. The second step, shown at 304, involves authenticating the user by authentication system 20. The third step, shown at 306, involves distribution and checking of a confirmation randomly generated password amongst authentication system 20, client 12 and financial institution 14. As an added condition, successful completion of the three steps must occur within a timed session. A session may be tens of seconds long, e.g. 90 seconds or some other timed interval which is sufficiently long to allow the user and the system to complete the sign-on process. If the session expires prior to successful completion of the steps, the logon attempt is failed. Each step is described in turn.

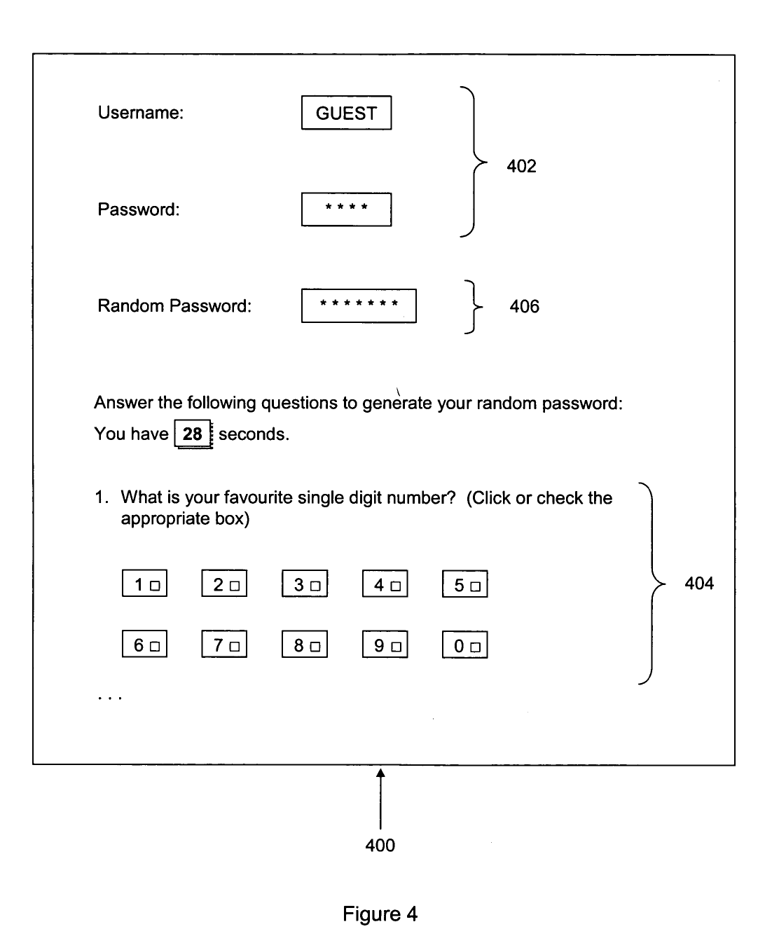

Referring to FIGS. 3 and 4, in the first step of authentication, a user at client 12 accesses a web-site hosted by financial institution 14 which, upon navigation by the user to the log-in screen for financial institution 14, provides him with log-in screen 400 which prompts him to provide his access account code and a password in area 402 and submit the information to financial institution 14.

Generally, user will input the requested information to client 12 via a keyboard and submit the data for transmission to financial institution 14. The data is provided as session information which provides the data, the I.P. address of client 12 and a time stamp to financial institution 14. When the information is received at financial institution 14, it compares the provided information to data in its database for the account access code. If the information matches, then the authentication process continues to the second step of authentication. If the information does not match either through a password or an account code mismatch, then client 12 is provided with a rejection notice generated either at client 12 or financial institution 14. At such time, user at client 12 may be invited to try to log-on again.

In the embodiment, authentication system defines a set of security identification numbers (SIDs) which are used to track users of accounts for all of the financial institutions tracked by the system. SIDs are each uniquely defined to define unique users. A set of SIDs are defined by authentication system 20 and then it allocates a set of SIDs to each financial institution 14. The financial institution 14 is allowed to allocate an SID from its set to a particular user associated with a particular account offered by the financial institution 14. The financial institution 14 keeps a record of the allocation of SIDs to its individual users and provides the allocation information to authentication system 20. Authentication system 20 receives the SID and performs a combination of shuffling and encryption of the SID based on a preset algorithm to convert the SID to another form of the SID which is used by authentication system 20 to associate the SID with the proper account information stored by the authentication system. This conversion is done to prevent unauthorized association of data to actual account owners.

As such, when a user at client at financial institution 14 signs on to his account, once the sign on information is verified, the financial institution 14 provides the SID and user information to authentication system 20 to further authenticate the user. As such, authentication system 20 has a centralized core of information which it can use to evaluate the authenticity of a purported user against his assigned identification information which is stored at authentication system 20.

To proceed with the second step of authentication, authentication system needs to communicate with client 12. To establish a communication link, once the first step is successfully completed, financial institution 14 provides an authentication signal to authentication system 20 containing the session information including the SID which is either extracted from the response provided by the user or generated from the responses provide by the user at the log-on screen. Upon receipt of the signal, authentication system 20 extracts the I.P. address of the user and the time stamp of from the session information. The I.P. address provides a known destination address for communications through link 18 with the unauthenticated user and the timestamp provides an initial starting time for the log-in session for the user.

In the embodiment, the user is provided with a question page generated by authentication system 20. Once the user has answered the questions, the answers are sent back to the authentication system 20 to be verified against data stored in shared memory 214. If the answers are verified, the answer to the learned question is stored in database 24 and a random password is generated by authentication system 20 and passed back to the user and to the financial institution where it is passed to the authentication system 20 for verification after which the user is permitted access if the random password matches that stored in shared memory 214.

In other embodiments, other tracking signals and information may be provided to enable authentication system 20 to identify client 12.

In order to isolate usage of the account access code from other elements in the system, authentication system 20 identifies information to be provided separately to each of client 12 and financial institution 14 utilizing an internal access code associated with the user. In particular, authentication system 20 has a mapping of internal account access codes to the access codes in database 24 containing account access codes of financial institution 14 mapped against the internal access codes, biographical information relating to the user.

For the second step of authentication, system 20 provides a series of questions to the user in a timed session through section 404 of GUI 400 and requires that the user provide enough correct answers to enough questions to obtain a level of confidence that the user has personal information which cannot be mimicked or spoofed by an impostor. Authentication system 20 poses each question to the user through a session on link 18 between authentication system 20 and client 12 using the I.P. address information derived from the authorization signal received from financial institution 14.

The query process 212 (FIG. 2) controls selection and invocation of questions for the second step. When initiated to identify a set of questions, query process 212 reads shared memory/pipes 214 and grabs an SID. Each SID has an associated financial institution and rules governing associated parameters for questions for it. Based on the SID, query process 212 reads the rules for the financial institution site that the SID is associated with and identifies or generates a predetermined question set. Typically the set comprises three questions; however more or less questions may be used.

The questions are stored in the authentication system database and server process 210A selects one set randomly when a user logs in. The rules will outline what types of questions to ask, the frequency of any specific questions based on the history.

Questions are posed from system 20 to client 12 and based on an analysis of answers provided to the questions, system 20 establishes a level of confidence of the authenticity of the user at client 12. The level of confidence indicates either that the user is authenticated or is an interloper and provides a decision to accept or reject client 12.

If a question is answered correctly, the confidence score is increased. If a question is not answered correctly, the confidence score is decreased. Once a minimum number of questions have been answered, if the confidence score surpasses a set confidence level, then the user is deemed to have answered enough of the questions correctly and the second step is successfully completed. One confidence threshold requires that all questions are answered correctly. Another threshold requires that one question deemed significant question is answered correctly. Other thresholds quantitative thresholds may be defined. If the initial answers do not pass the required the level of confidence, the query engine may provide one or more sets of questions to the user. Subsequently, if enough answers are correct such that the level of confidence is surpassed, then the second step of authentication is passed. However, if the confidence score does not surpass the confidence level or if the session times out, then the method may either terminate the second step, marking it as unsuccessful. The results of the second step are conveyed over the link 22 to the financial institution, which then continues the transaction or advised the user that the transaction cannot be completed.

In the embodiment, the questions are categorized into two broad categories: known and learned. Known questions have expected correct answers which are identified from information about the user provided from records from financial institution 14. Learned questions initially have no expected correct answer associated with them. When a learned question is provided to the user, what ever initial given answer the user provides is stored by system 20 as the correct answer for that question. If that question is posed again to the user, the expected answer is the initial answer.

For the second step of authentication, three exemplary methods of presenting questions are described below.

In the first method of presenting questions, the user is provided with a series of individual questions sequentially. Typically, three questions or more are presented, with one question from each type provided.

In the second method of presenting questions, questions are provided in defined sets. Therein, database 24 contains sets of questions which may be presented to the user. Table A illustrates three exemplary sets of questions stored in database 24.

TABLE A

| | | |
|---|---|---|
| Question | Text | Question Type |

Question Set #1

| | | |
|---|---|---|
| 1 | What is the second letter of | Known |
| | your surname? What is the | |
| | first initial of your first name? | |
| 2 | What is your favourite colour? | Learned/Learning |

Question Set #2

| | | |
|---|---|---|
| 1 | What is our favourite colour? | Learned/Learning |
| 2 | What is the first letter of your | Known |
| | of the street where you live? | |
| 3 | What is the first digit of the | Known |
| | exchange number of your | |
| | residential Telephone number? | |
| 1 | What is the first initial of your | Known |
| | first name? | |
| 2 | What is the first letter of your | Learned |
| | favourite city? | |
| 3 | What is the first letter of your | Learning |
| | favourite country? | |

It is noted that the sets of questions may have different numbers of questions, and that some of the questions may be similar or identical to questions in other sets. Once a set of questions is answered, authentication system 20 generates a confidence score which can be matched against a threshold in a manner as described above.

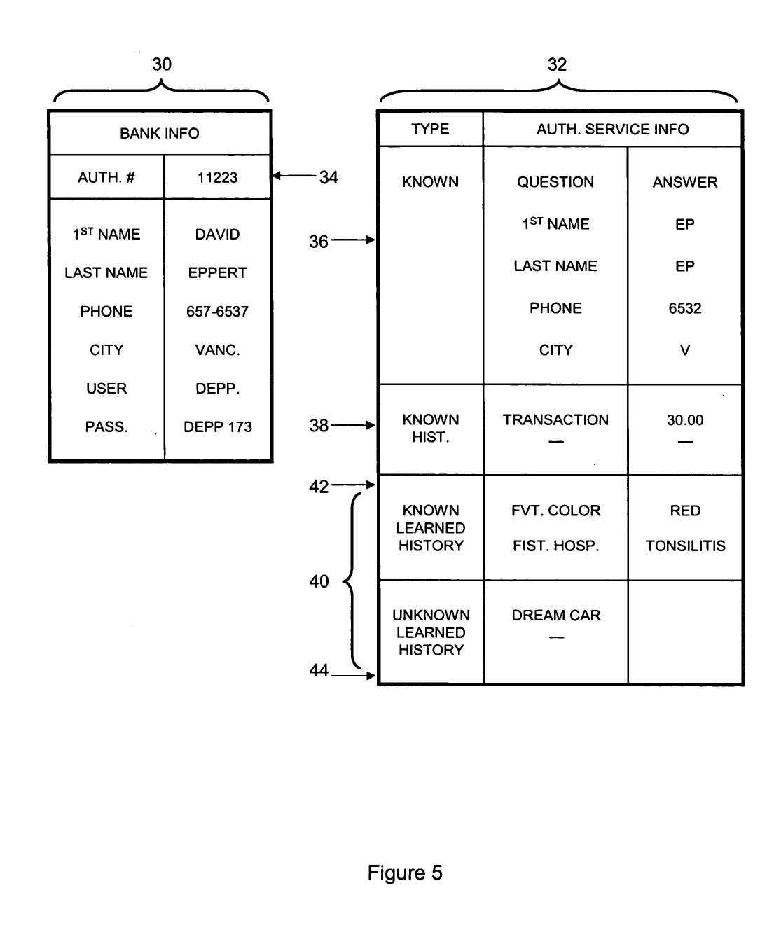

Referring to FIG. 5, for the third method of presenting questions, system 20 first identifies a type of questions to pose to the user, e.g. either known questions or learned questions. The specific question of that type is then selected from the record 32 and a further selection is then made as to the type of answer to be associated with the question. The type of answer is rotated and includes the option of a correct answer being present, the correct answer not being present and the correct answer not being known.

After the answer rotation has been selected, the multiple choice answers are populated where either the answer is present or the correct answer is not present. If, however, no answer has been received then an alternative branch is followed.

Referring back to FIG. 3, further detail is now provided on processing of questions and answers for the second step of authentication. In particular, authentication system 20 has a query processing engine 212 which selects a method of presenting questions to the user, identifies a question set for that selected method, identifies an expected answer set for the questions and processes the provided answers from the user. As noted earlier, questions are either known or learned.

In particular, step 1 in section 302 has the user providing his username and password to financial institution 14 for verification against its records. In step 2 in section 304, the financial institution 14 verifies the username and password provided with authentication system 20. After authentication system software is implemented into the financial institution, the financial institution then requires the user to provide a random password to the financial institution to be verified to the authentication system 20. In order for the user to acquire the random password, the user must successfully answer a series of questions presented by the authentication system 20. The user's session information, time and SID are sent to API 208B then passed to process 210B which starts a spawn of the authentication software which will handle this user session. The user is then sent to the authentication system web pages 206 which takes the user's session information, IP address, and time and passes it to API 208A which passes it to process 210A and matches it with the spawn for that session. Process 210A then stores the SID in shared memory to be retrieved later by query process 212 for further processing. Process 210A validates the session information, then logs the session to the log database 24, then pulls the questions and stored answers from the database 24 into the spawn process. Process 210A then passes the questions to the back to the user via API 208A. The user answers the question and the answers are passed back to process 210A via API 208A and verified with the answers stored in the process 210A spawn. If the answer is verified as being correct, process 210A generates a random password, stores the random password in shared memory 214, and passes the random password to the user and financial institution via API 208A which is then sent to process 210B for verification to the shared memory 214. If the random password matches along with a valid time on the random password, the user is permitted access. Finally in step 3 in section 306, authentication system 20 verifies the password, then generates a separate final password, based on input from the user provided in stage 2, which is used as a final automatic password provision and acceptance routine between client 12 and financial institution 14.

In selecting a method of presenting questions, the processing engine may cycle through the provided methods or utilize one preset method. Once a method is selected, sets of questions for the method may be identified using techniques described above.

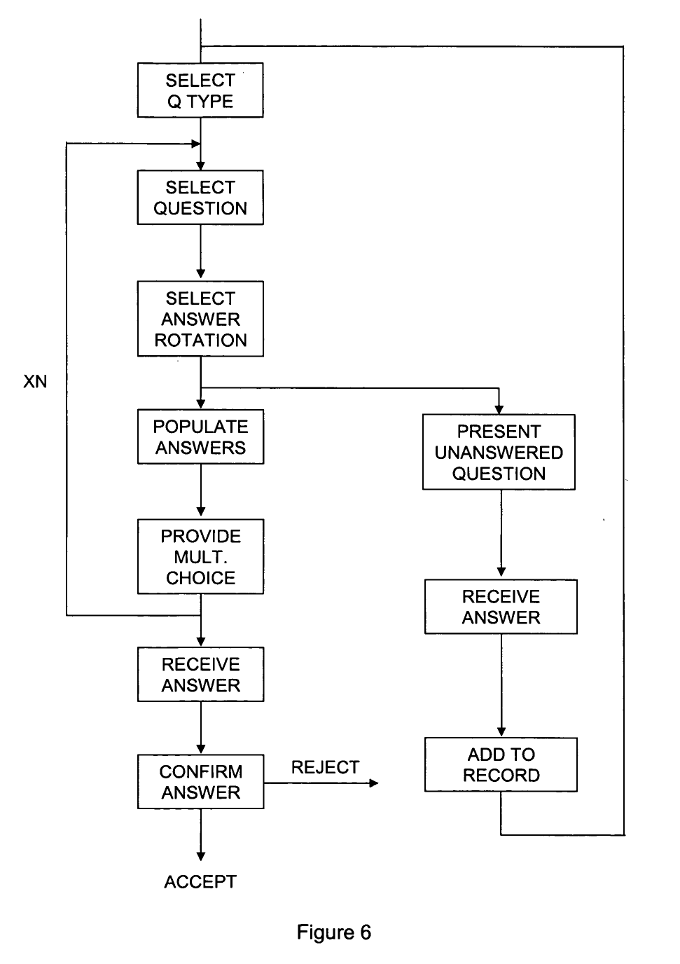

Referring to FIG. 6, to identify answers for known questions, expected answers are generated using a question template for the question and client information relating the user associated with client 12. The client information includes records 30 maintained by financial institution 14, including biographical details of the user (e.g., first name, last name, phone, address, username, and password). This information is maintained securely within the financial institution and is sufficient to fully identify the user. Included in the record 30 is a personal identification number 34 that identifies a common record within financial institution 14 and authentication system 20.

In authentication system 20, record 32 contains personal identification number 34 and is subdivided into a several fields. First field 36 contains known information which is fixed information from a known source, such as information in the bank record 30. Thus, the identification of first name, last name, phone number, and city is included in the known information but is incomplete in that it is compiled from a subset of the information contained in the bank record. The known information is information that may be known by somebody other than the particular client 12. A second field of information, identified at 38, is known history. This known history information 38 includes questions with answers that are derived from activities of the individual in the site being accessed. The answers are specific to the site and may be known by the individual and someone other than the individual. For example, the value of the last transaction performed on the site may be an example of known history.

To identify answers for learned questions, third field 40 stores a set of questions whose answers would only be known by the user and which are not part of the biographical data present in bank record 30. Examples of such questions may relate to a personal preference of the user, such as his favourite colour. Alternatively, such questions may relate to additional personal biographical data, such as the maiden name of the mother of the user. The learned history type is subdivided into learned history for which the questions have been answered by the individual identified at 42 and questions which have yet to be answered identified at 44. For a learned question which has never been posed to the user, the expected answer is the first answer provided by the user; for a learned question which already has been provided to the user, the expected answer has is the first answer provided by the user.

It is notable that the records in authentication system 20 do not singularly contain sufficient information to positively uniquely identify any user associated with any account. Accordingly, privacy of information of the data of users stored in authentication system 20 is maintained, as it is not possible to positively identify a user by using simply only the records in authentication system 20. Further, the exchange of confidential information between the financial institution and the service is limited.

To process answers for the questions, the query engine provides a selection of possible answers to the user with each question in the form of radio buttons and input fields presented in the GUI of the session. Generally, questions are designed to require a single digit or character answer in a multiple choice format. For example, for question 1 of set 1 in Table A, authentication system 20 provides in GUI 400 (FIG. 4) a set of radio boxes to the user for each numeric digit in area 404. When the user is presented with the question, he simply selects the radio button associated with the correct letter for the question utilizing a mouse input or a keystroke. It will be appreciated that using a mouse input reduces the ability for snooping answers by an unauthorized source.

Once an answer is provided by the user, client 12 submits it to query processing engine 212 for processing against the expected answer. Assuming that a multiple choice question is to be provided to client 12, the questions are transmitted through the communication link 18 to client 12 and the answers received from client 12 are monitored. The received answers are compared with the expected answers and if a correct answer is provided, then the level of confidence is increased.

When a learned question is present to the user for the first time, the answer provided is then added to the record into the learned history category 42. Preferably, such entry will only occur when a degree of confidence has been established that client 12 is authenticated, although such questions can be posed at any time.

Once the second step of authentication is passed, the third step of authentication provides a password passing routine between client 12, authentication system 20 and financial institution 14. While the session is still being monitored for expiry of its timed session, a sign-on password is generated by authentication system 20 and is separately provided to both client 12 and financial institution 14 for the user to submit the password to financial institution as a final sign-on procedure. Preferably, the sign-on password is unique to every instantiation of the authentication process by all users.

A first part of the password passing routine has financial institution 14 sending a request to client 12 for a password in a web page. In one embodiment, instead of the user at client 12 entering the password, the password is provided by authentication system 20 to client 12 and authentication system 20 also causes automatic population of a response containing the password in the web page and transmission of the response is provided to authentication system 20. The third step provides a further layer of security is provided as a hacker or unauthorized person or routine deters correct guessing or snooping of a password.

In the embodiment, the password is a pseudo-randomly generated alphanumeric string. In another embodiment, the password is generated using a combination of criteria as seeds, which may include portions of questions, session information, SID, random information, and other relative information. An answer provided in the second step of authentication may also be used as a key in generating the password. In other embodiments a password is selected from a pre-existing list of passwords securely stored by authentication system 20. Once the password is generated, it is stored by authentication system in token database 214 (FIG. 2).

The password may be generated from a combination of information related to, but not limited to one or more of the user's particular session information, host name, timestamp and SID. Once selected, the information can be segmented into pieces and particular pieces may be selected, then the selected pieces may be encrypted and parsed to define a random password for the user. It will be appreciated that other password generation algorithms may be used. Algorithms may change based on various implementation environments.

In the embodiment, if the session has not timed out, the password is automatically passed from the authentication system 20 to the log-in screen 300 at area 304 (FIG. 3), which then sends the password to the financial institution 14 for further verification and processing. It will be appreciated that the duration of the session should be set in order to provide sufficient time to safely complete the authentication process, but provide as small an excess time as possible, in order to limit the ability of hackers to infiltrate and subvert the system in during the life of the session.

Once financial institution 14 receives the password, it checks the password against what is provided by authentication system 20. In the automatic mode, the password is verified and the user is provided access to its accounts on financial institution 14.

It will be appreciated that the system and method of the embodiment provide a continuous session for the user for the entire sign-on process. In particular, the user is provided with a one set of screens which appear to be originating from one source for the initial sign-on, question and answer, verification and password passing processes.

It will be appreciated that the described invention and its embodiments provides a method of verifying the presence of an authorized user of an account without storing information that may be used to determine the user's identity. The embodiment uses personal preferences or items retained in a user's memory to assist in verifying the identity of the user.

Although the invention has been described with reference to certain specific embodiments, various modifications thereof will be apparent to those skilled in the art without departing from the scope of the invention as outlined in the claims appended hereto.

1. A method of authenticating a user of an account at a service system using an authentication system, said method comprising:
after said user successfully completes an initial sign-on procedure with said service system, providing a set of authentication questions to said user from said authentication system;
receiving and analyzing answers from said user to said set of questions against expected answers;
if said answers provide a sufficient level of confidence in the authenticity of said user, then providing a sign-on password to said user and to said service system for use for said user to submit said password to said service system to access said account.

2. The method of authenticating a user to a service system using an authentication system, as claimed in claim 1 further comprising
automatically submitting said sign-on password from said user to said service system for verification; and
upon completion of verification, allowing said user access to said account.

3. The method of authenticating a user to a service system using an authentication system, as claimed in claim 2 wherein
said authentication system stores account information related to said user obtained from said service system and said answer received from said user; and
said answers for said set of questions are distinct from said account information.

4. The method of authenticating a user to a service system using an authentication system, as claimed in claim 3 wherein if said answers do not provide said sufficient level of confidence, then said system does not authenticate said user.

5. The method of authenticating a user to a service system using an authentication system, as claimed in claim 4 wherein if said answers are not provided within a preset time limit, said system does not authenticate said user.

6. The method of authenticating a user to a service system using an authentication system, as claimed in claim 5 wherein for a question of said questions, an expected answer for said question is a given answer provided by said user to said question.

7. The method of authenticating a user to a service system using an authentication system, as claimed in claim 6 wherein said given answer is stored with said expected answers and becomes an expected answer for said question.

8. The method of authenticating a user to a service system using an authentication system, as claimed in claim 7 wherein said sign-on password is generated utilizing at least one answer from said answers as an encryption seed.

9. The method of authenticating a user to a service system using an authentication system, as claimed in claim 8 wherein said method is completed in one session which extends from said initial sign-on procedure.

10. The method of authenticating a user to a service system using an authentication system, as claimed in claim 9 wherein said expected answers are each single alphanumeric characters.

11. A system for authenticating a user of an account, said system comprising:
an authentication system;
a service system having a plurality of accounts and users for said plurality of accounts;
a set of security identification tags for said users,
wherein
after said user successfully completes an initial sign-on procedure with said service system, said authentication system provides an authentication question to said user;
after said user provides an answer to said authentication question, said authentication system receives and analyzing an answer from said user to said question;
if said answer provides a sufficient level of confidence in the authenticity of said user, said authentication system provides a sign-on password to said user and to said service system for use for said user to submit said password to said service system to access said account.

12. The system for authenticating a user of an account, as claimed in claim 11, wherein
said authentication system automatically submits said sign-on password from said user to said service system for verification; and
upon completion of verification, said authentication system automatically allows said user access to said account.

13. The system for authenticating a user of an account, as claimed in claim 12, wherein
said authentication system stores account information related to said user obtained from said service system and said answer received from said user;
said answers for said set of questions are distinct from said account information; and
if said answers do not provide said sufficient level of confidence, then said system does not authenticate said user.

14. The system for authenticating a user of an account, as claimed in claim 13 wherein for a question of said questions:
an expected answer for said question is a given answer provided by said user to said question; and
said given answer is stored with said expected answers and becomes an expected answer for said question.

15. The system for authenticating a user of an account, as claimed in claim 14, wherein said sign-on password is generated utilizing at least one answer from said answers as an encryption seed.
